(19) United States
(12) Patent Application Publication
(10) Pub. No.: US 2004/0126215 A1
(43) Pub. Date: Jul. 1, 2004

(54) Conversion kit for utilizing off-loading ramps as a trailer to be pulled behind an all-terrain vehicle and method for using same

(76) Inventor: Ryan N. Long, Rusk, TX (US)

Correspondence Address: William E. Johnson, Jr., THE MATTHEWS FIRM, Suite 1800, 1900 West Loop South, Houston, TX, 77027, US

(21) Appl. No.: 10/662,920

(22) Filed: Sep. 15, 2003

Related U.S. Application Data
(60) Provisional application No. 60/410,351, filed on Sep. 16, 2002.

(51) Int. Cl. B60P 1/00

(52) U.S. Cl. 414/537

(57) ABSTRACT

An all-terrain vehicle (ATV) is off-loaded from a pickup truck by running it down a bi-fold ramp to the Earth's surface. A conversion kit is then used to add a pair of wheels to the ramp, along with a tow-bar connected between the ramp and the ATV. A support bar is then added between the two halves of the bi-fold ramp to prevent folding of the ramp when under load. To reverse the process, the tow bar and the wheels are removed from the ramp and the upper end of the ramp attached to the pickup truck to allow the ATV to be run up the ramp into the bed of the pickup truck. The support rod is removed from the ramp, the ramp is folded and then the folded ramp is placed into the rear of the pickup truck underneath the ATV.

### RELATED APPLICATION

This application claims priority from U.S. Provisional Patent Application Serial No. 60/410,351, filed on Sep. 16, 2002.

### BACKGROUND OF THE INVENTION

It is well known to transport all-terrain vehicles (“ATV”) in the back of pickup trucks and also to transport in such pickup trucks one or more off-loading ramps which can be easily secured to the back of the pickup truck with their other ends on the ground so that the ATV can be run down the ramps to get them out of the pickup trucks. Once the ATV is unloaded from the pickup truck, by running it down the one or more ramps, the ATV can then be driven off for whatever purpose is desired, such as just driving around in the woods, for hunting, or whatever. These types of ramps, typically manufactured from aluminum so as to be light-weight, are available from various manufacturers and distributors for such manufacturers, but a great variety of such ramps are available from Five Star Manufacturing, Inc., located at 104 Industrial Drive, Crane, Mo. 65633. Such ramps are typically twelve inches wide but can also be obtained as off-the-shelf items which run all the way from five or six inches up to 40-60 inches.

As most deer and elk hunters know, if one rides the four-wheel ATV out several miles away from the pickup truck, and one is fortunate enough to kill a deer or an elk, there can be a great amount of difficulty in taking the deer or elk back to the pickup truck.

The present invention contemplates the use of a conversion kit which uses a bi-fold ramp, or which couples a pair of ramps together and which also provides a pair of wheels attached to the ramps on the opposite sides of the ramps when coupled together, and which also provides a towing bar (sometimes referred to as a “tongue”) connected between the back of the ATV and the combined ramps to be used as a utility trailer which can be towed by the ATV. The use of the utility trailer according to the present invention is not limited to hauling harvested game such as deer or elk, but also can be used to haul wood or other loads as desired.

### BRIEF DESCRIPTION OF THE DRAWINGS

FIG. 1 is a top-plan view of a pair of ramps, known in the prior art, which can be used to off-load either a tractor or an ATV vehicle from the bed of a pickup truck;

FIG. 2 is a top-plan view of a bi-fold ramp, also known in the prior art, which can be used to off-load a tractor or an ATV vehicle from the bed of a pickup truck;

FIG. 3 is a top-plan view of the bi-fold ramp, illustrated in FIG. 2, but which has been modified in accordance with the present invention to include a pair of wheels and also a tow bar contemplated to be connected to the back end of the ATV after it is off-loaded from a pickup truck;

FIG. 3a is an elevational, pictorial view of a prior art spring-loaded pin which can be used to pin various components to the bi-fold ramp in accordance with the present invention;

FIG. 4 is a side view, partly in cross section, of an end portion of the tow bar illustrated in FIG. 3.

FIG. 5 is a pictorial view of an ATV being loaded or unloaded using one or more ramps connected between the ground and the bed of a pickup truck;

FIG. 6 is an isometric, pictorial view of the utility trailer according to the present invention connected by a towing bar to an ATV;

FIG. 7 is a top-plan view of a bracket and sliding bar assembly used to prevent the bi-fold ramp from folding other than when the sliding bar is removed from the assembly;

FIG. 8 is an elevated view of one of the wheel assemblies which can be used with the utility trailer in accordance with the present invention; and

FIG. 9 is an end view of the wheel assembly illustrated in FIG. 8.

### DETAILED DESCRIPTION OF THE PREFERRED EMBODIMENT OF THE INVENTION

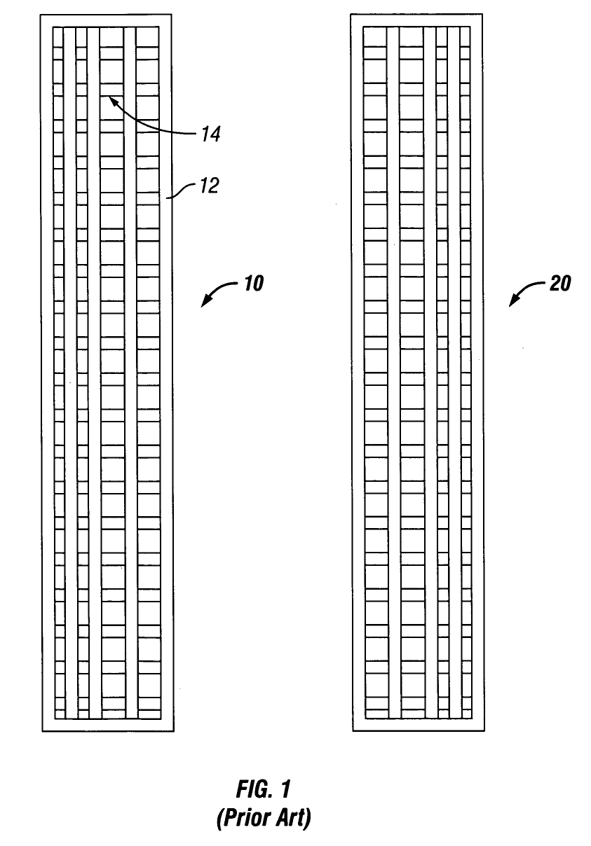

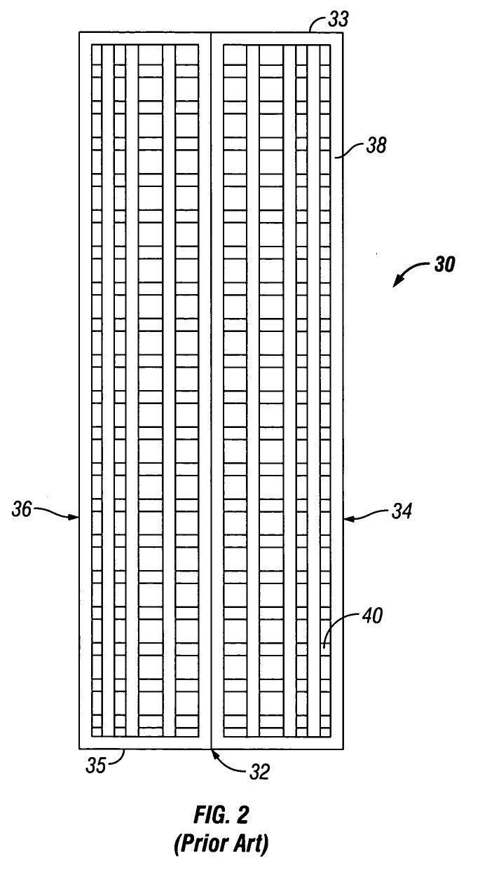

Referring now to the drawings in more detail, FIG. 1 illustrates a top-plan view of a pair of off-loading ramps 10 and 20, respectively, which can be used to off-load an ATV from the bed of a truck, for example, a pickup truck, not illustrated in FIG. 1. These types of ramps, well known in this art, typically utilize one inch square aluminum tubing such as the parallel tubing members 12 and the cross members 14. The ramps 10 and 20 typically will be between twelve and eighteen inches wide and can be six to eight feet long as needed to unload an ATV or a farm tractor from the bed of a pickup truck. Although not involving the preferred embodiment of the present invention, the ramps 10 and 20 can be moved closer together, even to the point of touching each other, to function nearly identical to the bi-fold ramp illustrated in FIG. 2, and which is described in more detail hereinafter.

Referring now to FIG. 2, there is illustrated a bi-fold ramp 30 which has a centerline 32 between a pair of ramps 34 and 36 which allows the ramp 34 to fold over onto the top of the ramp 36. The centerline 32 is the longitudinal axis of the bi-fold ramp 30 and passes through the ends 33 and 35. The prior art bi-fold ramps 30 are manufactured essentially identical to the two ramps illustrated in FIG. 1 and are typically manufactured from one inch square aluminum tubing, both as to the parallel members 38 and the cross-members 40. The bi-fold ramps such as the ramp 30 are made to fold the ramp 34 over on top of the ramp 36 to enable it to be stowed more easily in the bed of the pickup truck (not illustrated in FIG. 2).

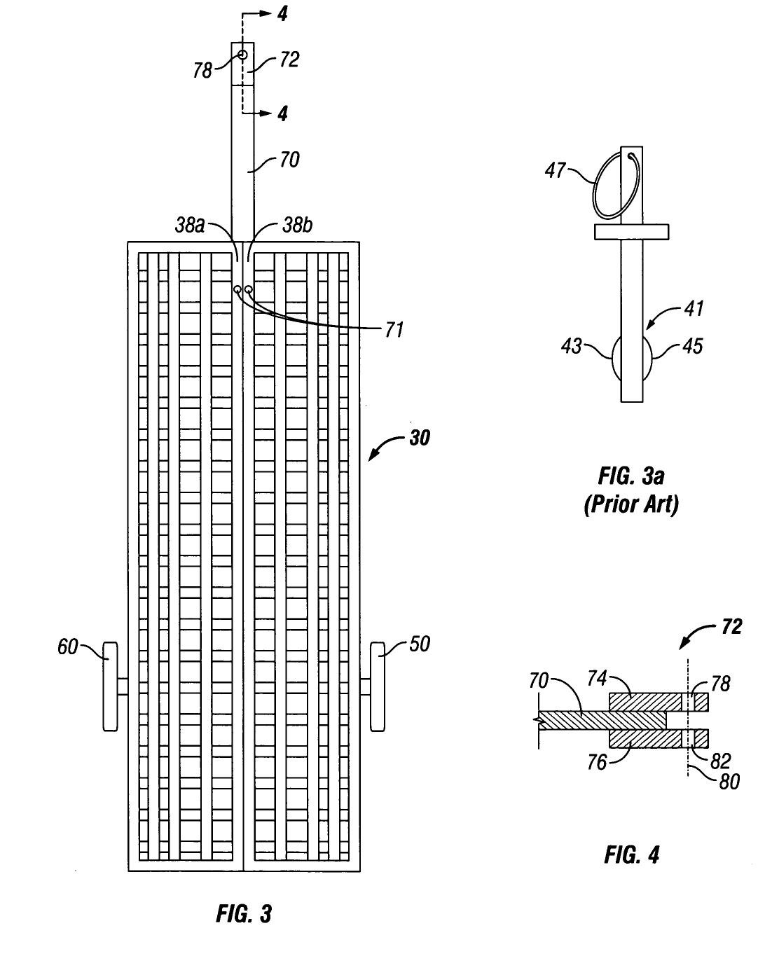

FIG. 3 illustrates the bi-fold ramp 30 in accordance with the present invention, which has been modified to include a pair of wheels 50 and 60 and also a towing bar 70, which can be attached to the back end of an ATV, or even to the back end of a farm tractor (not illustrated in FIG. 3).

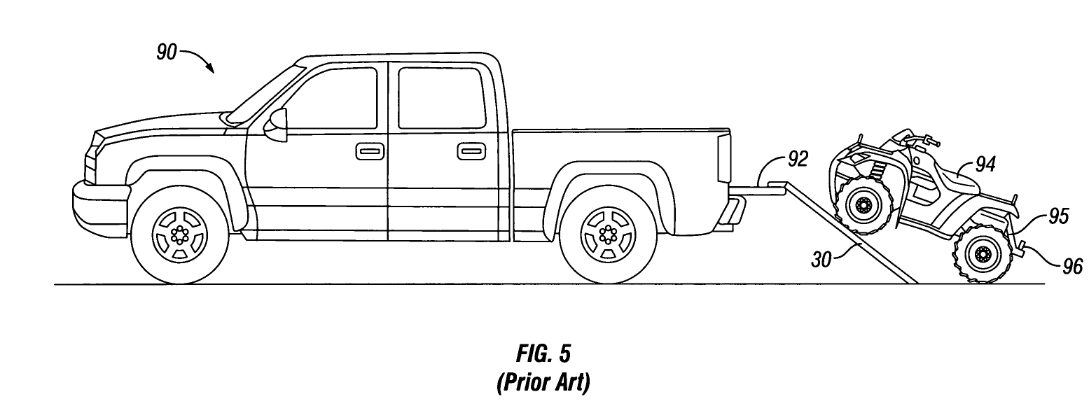

As illustrated in FIG. 4, there is illustrated a connection 72, partially in cross-section, which enables the connection of the tow bar 70 to the back end of an ATV. The connection 72 can be made in various ways, but in the preferred mode of the invention, the connection 72 includes a top plate 74 and a bottom plate 76, each of which is welded or otherwise secured to the tow bar 70, and each of which has a hole therethrough to provide access to a bolt 96 (See FIG. 5) along the centerline 80 of the two holes 78 and 82.

The other end of tow bar 70 (away from the end 72) can be pinned or otherwise connected to one or more of the parallel bars 38, and/or to one or more of the cross bars 40, all as illustrated in FIG. 2. If using pins, one or more holes 71 can be drilled through the tow bar 70 and through the parallel bars 38a and/or 38b, and one or more pins 41 inserted therethrough to thus securely connect the tow bar 70 at or near the end 33 of the bi-fold ramp 30. FIG. 3a illustrates a conventional spring-loaded pin 41 which can be used for that purpose. The pin 41 is used by inserting it through a pair of aligned holes, for example, through a first hole in the tow bar and through a second hole in the parallel bar 38b. As the pin 41 is thus inserted, the bow springs 43 and 45 depress and then expand to lock the pin 41 in place. To remove the tow bar, the pins are removable merely by pulling hard on the handle loop 47. As an alternative, other fasteners such as nuts and bolts can be used to connect the tow bar to the bi-fold ramp.

It should be appreciated that in connecting the tow bar to the bi-fold ramp, and in connecting wheels to the bi-fold ramp, and in connecting the rod 120 between the two halves of the bi-fold ramp, the hardware for making such connections is not particularly important other than for the ease and speed of connection. Thus, all of those elements can be connected by using a pin such as the pin of FIG. 3a, or other fasteners can be used such as nuts and bolts, or other well-known fasteners can be used.

Referring now to FIG. 5, there is illustrated a pickup truck 90 which is itself conventional and known in the art. The pickup truck 90 has a bed (not numbered or shown in FIG. 5) into which an ATV can be transported. The pickup truck 90 has a tailgate 92 to which one or more loading ramps 30 can be attached to allow the ATV 94, which is also conventional and known in this art, to be downloaded or loaded by running the ATV either up or down the one or more loading ramps 30. The ATV 94 also has an attachment 95 near the back end and having an attachment 96, which may either be a conventional trailer hitch or a bolt for connection to the holes 78 and 80, illustrated in FIG. 4, for connecting the tow bar to 70 to the ATV 94, illustrated in FIG. 5.

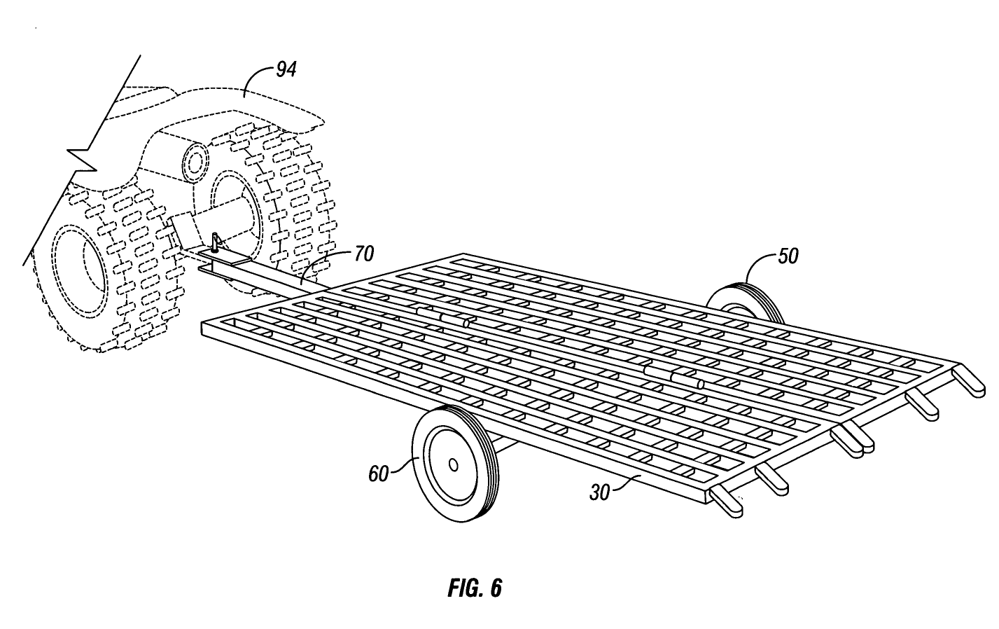

Referring now to FIG. 6, the bi-fold ramp 30 is illustrated as having its tow bar 70 connected between the ramp 30 and the ATV. The bi-fold ramp 30 is also illustrated as having one of its wheels—wheel 60—which together with wheel 50 (not illustrated in FIG. 6)allows the ramp 30 to be used as a utility trailer behind the ATV 94. FIG. 6 also illustrates various loads (unnumbered) which can be transported by the towed ramp 30 behind the ATV 94.

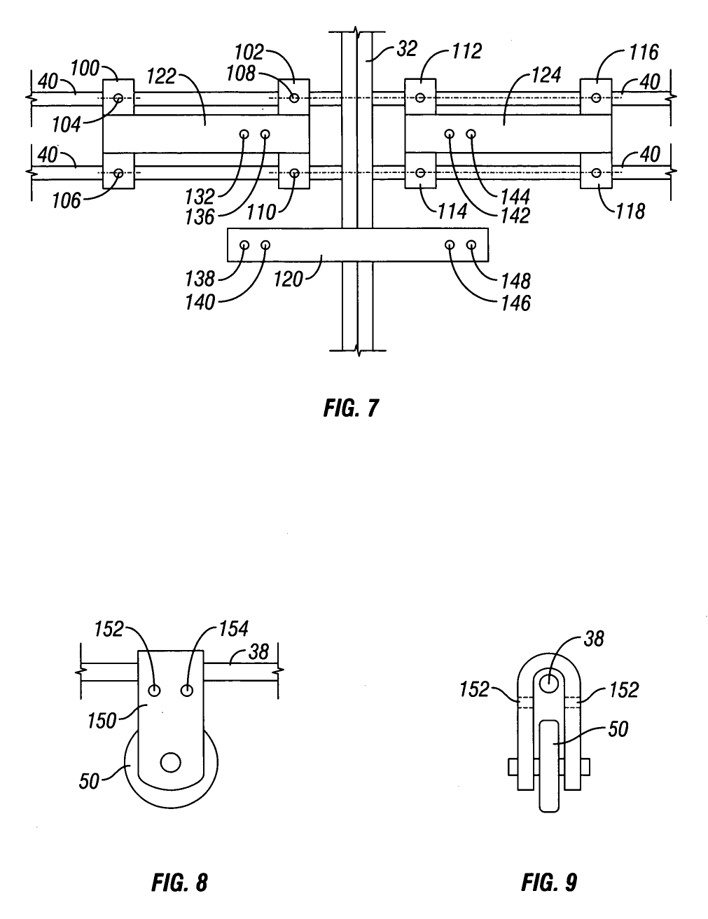

Referring now to FIG. 7, there is illustrated a pair of brackets 100 and 102 which are pinned to two of the cross-members 40 associated with the one half 36 of the bi-fold ramp 30 through the holes 104, 106, 108 and 110, for example, as discussed herein with respect to the description of FIG. 3a. In a similar vein, there are two sets of brackets 112, 114, 116 and 118, which are also pinned to the cross-members 40, illustrated in FIG. 2 for the second half 34 of the bi-fold ramp 30, illustrated in FIG. 2. It should be appreciated that the brackets of the one half 36 of the bi-fold ramp 30 in FIG. 2 are identical to the brackets which are used with the one half 34 of the bi-fold ramp 30 illustrated in FIG. 2. The sliding rod 120 is sized to be slidably inserted and then removed from the interior of the two channels 122 and 124.

In the operation of the methods and apparatus according to the present invention, the bi-fold ramp 30, as shown in FIG. 2, and as modified in FIG. 3, is attached to the rear end of the pickup truck, illustrated in FIG. 5, and having the lower end of the ramp 30 resting on the Earth's surface as shown in FIG. 5. The ATV is then caused to move down the ramp 30 from the bed of the pickup truck to allow the ATV to now be on all four wheels resting on the Earth's surface. The tow bar 70 is attached at or near to a first end of the bi-fold ramp 30. The wheels 50 and 60 are pinned to the respective sides of the bi-fold ramp, as illustrated in FIGS. 3, 8 and 9. The sliding bar 122 is pinned in place within the two sets of brackets, as illustrated in FIG. 7, and the tow bar 70 is connected to the connection 96 located at the rear end of the ATV, as illustrated in FIG. 5. After the wheels and the tow bar and the support rod 120 are thus in place behind the ATV, the ATV can then be driven around as desired pulling the utility trailer behind it according to the present invention. At the end of the day, the combined ATV and utility trailer can then be returned to the pickup truck and the process reversed. In the reversing of this process, the tow bar 70 is disconnected from the back of the ATV, and the tow bar 70 is then released from the bi-fold ramp 30. The bar 120 is unpinned from the brackets in FIG. 7 to thus allow a folding of the bi-fold ramp when desired. The two wheels 50 and 60 are then removed from the bi-fold ramp 30 and, after removing the wheels from the bi-fold ramp, the ramp 30 can then be connected to the back of the pickup truck with the other end laying on the Earth's surface. This allows the ATV to be driven up the ramp and to thus be loaded in the bed of the pickup truck.

The support rod 120 can then be unpinned from the bi-fold ramp 30 and the wheels 50 and 60 unpinned from the respective sides of the bi-fold ramp 30. The ramp 30 can then be folded at the fold line 32 and the wheels 50 and 60 can be pinned to the same side of the ramp 30 and the ramp loaded into the pickup truck underneath the ATV.

1. A method for transporting loads behind an all-terrain vehicle, comprising:
transporting an all-terrain vehicle in the bed of a pick-up truck;
off-loading said all-terrain vehicle from the bed of said pickup truck by moving said all-terrain vehicle to the Earth's surface down a bi-fold loading ramp having a longitudinal axis;
connecting first and second wheels to said loading ramp on opposite sides of said longitudinal axis;
connecting a first end of a tow-bar on or near an end of said loading ramp through which said longitudinal axis passes;
connecting a second end of said tow-bar to said all-terrain vehicle;
placing a load on top of said ramp; and
pulling said loaded ramp with said all-terrain vehicle.

2. The method according to claim 1, comprising the additional step of locking said bi-fold ramp against folding prior to placing a load on top of said bi-fold loading ramp.

3. The method according to claim 2, comprising an addition thereto, the steps of:
removing the load from said loading ramp;
disconnecting the tow-bar from the loading ramp and from the all-terrain vehicle;
disconnecting the first and second wheels from said loading ramp;
loading said all-terrain vehicle into said pick-up truck by moving said all-terrain vehicle up said ramp from the Earth's surface to the bed of said pickup truck;
folding said loading ramp; and
stowing said folded loading ramp in said pickup truck.

4. A kit for converting a bi-fold loading ramp into a towable utility trailer, comprising:
a) a bi-fold loading ramp having first and second ramps in juxtaposition with each other, and having a longitudinal axis and a first end through which said longitudinal axis passes;
b) first and second wheels connectable to said loading ramp on opposite sides of said longitudinal axis;
c) a tow bar connectable at or near said first end of said bi-fold loading ramp; and
d) a support bar positional between said first and second ramps to prevent said bi-fold ramp from folding under load.
